(19) United States
(12) Patent Application Publication
(10) Pub. No.: US 2023/0266545 A1
(43) Pub. Date: Aug. 24, 2023

(54) DUAL-LAYER GRATING COUPLER

(71) Applicant: Cisco Technology, Inc., San Jose, CA (US)

(72) Inventors: Roman BRUCK, Vienna (AT); Attila MEKIS, Carlsbad, CA (US)

(21) Appl. No.: 17/652,408

(22) Filed: Feb. 24, 2022

(51) Int. Cl. G02B 6/42

(52) U.S. Cl. CPC G02B 6/4215; G02B 6/42

(57) ABSTRACT

According to an embodiment, an apparatus includes a first grating and a second grating in a stack with the first grating. The first grating includes a first plurality of scatterers in a first two-dimensional (2D) arrangement. The second grating includes a second plurality of scatterers in a second 2D arrangement. The first grating and the second grating are arranged to redirect a first optical signal and a second optical signal traveling through the stack. The first optical signal enters the stack in a first direction, and the second optical signal enters the stack in a second direction different from the first direction. Each of the second plurality of scatterers is offset from a corresponding scatterer of the first plurality of scatterers in a third direction different from the first and second directions. Other embodiments include a method performed by the apparatus.

### TECHNICAL FIELD

Embodiments presented in this disclosure generally relate to optical communications. More specifically, embodiments disclosed herein relate to a dual-layer grating coupler for optical communications.

### BACKGROUND

Grating couplers facilitate the coupling of light between photonic integrated circuits and external optical components, typically optical fibers. This coupling may result in losses. The loss mechanism that is typically most difficult to minimize is directionality (e.g., some of the light is directed away from the optical fiber, e.g. towards the substrate, where it cannot be collected). Gratings may be fabricated by etching a planar waveguiding material. In such cases, directionality is a function of the thickness of the optical waveguiding layer and the etch depth. Neither of the two parameters can be freely chosen in the design of a photonic device library because the performance characteristics of other devices depend on these parameters as well. Even when prioritizing gratings in the choice of waveguide layer thickness and etch depth, significant losses due to directionality remain when using a single etch step, as is the case in many photonic platforms.

In two-dimensional gratings (2D gratings), where two or more beams propagate simultaneously in the grating plane, 2D diffractive patterns may be needed. Such gratings offer additional functionality (e.g., they allow coupling of all polarization states, or of two separate wavelengths, simultaneously). Loss optimization of 2D gratings is limited because the multiple light beams propagating in different directions in the waveguiding layer pose different, often conflicting, requirements to the design of the diffractive pattern.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example grating coupler in the system of FIG. 1.

FIG. 3 illustrates an example grating in the system of FIG. 1.

FIG. 4 illustrates an example grating in the system of FIG. 1.

FIG. 5 illustrates an example grating coupler in the system of FIG. 1.

FIG. 6 illustrates an example grating coupler in the system of FIG. 1.

FIG. 7 illustrates an example grating coupler in the system of FIG. 1.

FIG. 8 is a flowchart of an example method performed in the system of FIG. 1.

FIGS. 9A through 9G illustrate the formation of an example grating coupler in the system of FIG. 1.

FIG. 10 is a flowchart of an example method for forming the grating coupler of FIGS. 9A through 9G.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to an embodiment, an apparatus includes a first grating and a second grating in a stack with the first grating. The first grating includes a first plurality of scatterers in a first two-dimensional (2D) arrangement. The second grating includes a second plurality of scatterers in a second 2D arrangement. The first grating and the second grating are arranged to redirect a first optical signal and a second optical signal traveling through the stack. The first optical signal enters the stack in a first direction, and the second optical signal enters the stack in a second direction different from the first direction. Each of the second plurality of scatterers is offset from a corresponding scatterer of the first plurality of scatterers in a third direction different from the first and second directions. Other embodiments include a method performed by the apparatus.

According to another embodiment, an apparatus includes a substrate and a grating coupler arranged above the substrate. The grating coupler includes a plurality of gratings arranged to redirect a plurality of optical signals traveling through the grating coupler in a plurality of different directions. The plurality of gratings includes a plurality of 2D arrangements of scatterers. Scatterers in a first 2D arrangement of the plurality of 2D arrangements are offset from scatterers in a second 2D arrangement of the plurality of 2D arrangements in a direction different from the plurality of different directions. Other embodiments include a method performed by the apparatus.

According to another embodiment, a method includes disposing a first layer above a substrate and etching the first layer to form a first grating that includes a first plurality of scatterers. The method also includes disposing a second layer on the first layer and etching the second layer to form a second grating that includes a second plurality of scatterers such that the first layer and the second layer form a grating coupler arranged to redirect a first optical signal traveling through the grating coupler in a first direction and a second optical signal traveling through the grating coupler in a second direction different from the first direction. One or more of the second plurality of scatterers at least partially overlaps with and is offset from a corresponding scatterer of the first plurality of scatterers in a third direction different from the first and second directions. Other embodiments include an apparatus formed by performing the method.

### Example Embodiments

This disclosure describes a dual-layer grating coupler that uses offset scatterers in stacked gratings to redirect optical signals. Specifically, the grating coupler includes a first grating and a second grating overlaid on the first grating. Both gratings include scatterers in two-dimensional (2D) arrangements in parallel grating planes. Generally, the scatterers in the second grating are offset from the scatterers in the first grating in a direction that is different from the direction of optical signals incident on the dual-layer grating coupler. For example, a first optical signal and a second optical signal may enter the grating coupler from two different directions, and the scatterers in the second grating are offset from the scatterers in the first grating in a third direction that is different from the two directions of the incident optical signals. In this manner, the dual-layer grating coupler redirects the optical signals while reducing losses (e.g., directionality losses) relative to conventional 2D grating couplers, in certain embodiments. For example, directionality losses in some embodiments may be reduced from a conventional 1.3 dB to 0.3 dB or from a conventional 0.6 dB to 0.2 dB. Additionally, due to the high directionality of the grating coupler, the design is effectively decoupled from the thickness of a buried oxide layer between a substrate and the grating coupler. As a result, the thickness of the buried oxide layer may be chosen freely to improve the performance of other devices.

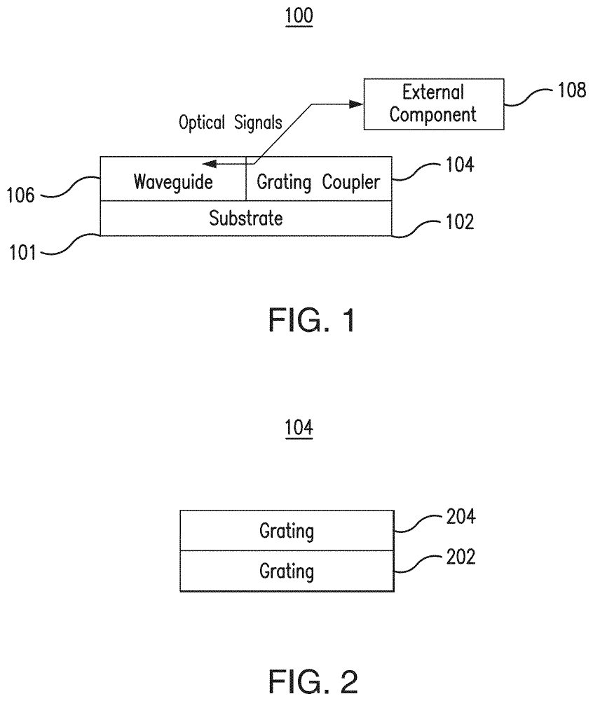

FIG. 1 illustrates an example system 100. As seen in FIG. 1, the system 100 includes a photonic integrated circuit 101, which includes a substrate 102, a grating coupler 104, and a waveguide 106. The system 100 also includes an external component 108. Generally, the grating coupler 104 redirects optical signals between the photonic integrated circuit 101 and the external component 108. For instance, optical signals may be transported on the photonic integrated circuit 101 using the waveguide 106 for purposes of processing, modulation, detection, or conversion to electric signals. In particular embodiments, the grating coupler 104 is a dual-layer grating coupler 104 with offset scatterers that reduce directionality losses in the grating coupler 104.

The substrate 102 forms a foundation for the other components in the photonic integrated circuit 101. For example, the grating coupler 104 may be disposed on the substrate 102. In some embodiments, a buried oxide layer is disposed on the substrate 102, and the grating coupler 104 is disposed on the buried oxide layer. The substrate 102 may be formed using any suitable material. For example, the substrate 102 may be made using silicon or another semiconductor material.

The grating coupler 104 is disposed above the substrate 102 and redirects incident optical signals. In some embodiments, the grating coupler 104 includes multiple layers of gratings that reduce directionality losses. For example, the grating coupler 104 may include two gratings with one grating overlaid on the other. This grating arrangement may reduce the amount of light or optical signals that the grating coupler 104 redirects towards the substrate 102. Instead, the grating arrangement increases the amount of light or optical signals that the grating coupler 104 redirects towards the external optical component 108. Each of the gratings may be a two-dimensional grating. For example, the gratings may redirect two optical signals that are incident on the grating coupler 104 from orthogonal directions. The system also operates in reverse. In a configuration where the optical signal is incident from the external optical component 108 onto the grating coupler 104, and the grating coupler 104 redirects the optical signal into two orthogonal directions parallel to the substrate 102.

The waveguide 106 carries an optical signal from the grating coupler 104 to other portions of the photonic integrated circuit 101. For example, the waveguide 106 may carry the optical signal to another portion of the photonic integrated circuit 101 that converts the optical signal to an electric signal. The waveguide 106 may also carry an optical signal to the grating coupler 104. For example, the waveguide 106 may carry an optical signal from another portion of the photonic integrated circuit 101 to the grating coupler 104, which then redirects the optical signal to the external component 108. In some embodiments, the waveguide 106 may carry multiple optical signals to and from the grating coupler 104. In another example, multiple waveguides 106 may carry optical signals to and from the grating coupler 104. These optical signals may travel in different directions into or out of the grating coupler 104.

The external optical component 108 is positioned in the system 100 such that the grating coupler 104 redirects optical signals between the external optical component 108 and the photonic integrated circuit 101 incurring low loss. In the example of FIG. 1, the external optical component 108 is disposed above the grating coupler 104, but it is contemplated that the external optical component 108 may also touch or contact the grating coupler 104. The external optical component 108 may include one or more optic fibers that carry optical signals to or from the photonic integrated circuit 101. In another example, the external optical component 108 may include one or more lenses.

FIG. 2 illustrates an example grating coupler 104 in the system 100 of FIG. 1. As seen in FIG. 2, the grating coupler 104 includes multiple grating layers. Specifically, the grating coupler 104 includes a grating 202 and a grating 204 (but could include more gratings). The grating 204 is overlaid on the grating 202. Each of the gratings 202 and 204 include a two-dimensional arrangement of scatterers. In certain embodiments, the scatterers in the grating 204 are offset from the scatterers in the grating 202 such that directionality losses in the grating coupler 104 (e.g., by reducing the amount of optical power redirected towards the substrate 102, shown in FIG. 1) are reduced. The gratings 202 and 204 may have different thicknesses. For example, the grating 202 may have a thickness of 200 nanometers, and the grating 204 may have a thickness of 60 nanometers. The gratings 202 and 204 may be created using different materials. For example, the grating 202 may be made from silicon, and the grating 204 may be made from silicon nitride.

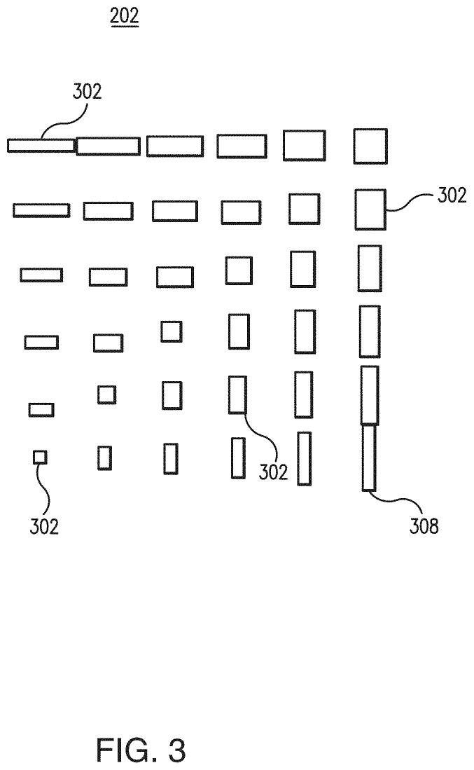

FIG. 3 illustrates a top-down view of an example grating 202 in the system 100 of FIG. 1. As shown in FIG. 3, the grating 202 includes multiple scatterers 302 in a two-dimensional arrangement. For clarity, not all of the scatterers 302 in the grating 202 are labeled in FIG. 3.

The scatterers 302 may be formed using any suitable material (e.g., a silicon-based material). For example, the scatterers 302 may be formed using a transparent, dielectric material. The scatterers 302 may be formed by etching away portions of the dielectric material. The size, shape, and spacing of the scatterers 302 may be controlled through the etching process. Additionally, the scatterers 302 are sized, shaped, and positioned to redirect incident optical signals in a particular direction (e.g., towards an external optical component 108). The scatterers 302 are arranged in a grating plane 308 in the grating 202. As seen in FIG. 3, the scatterers 302 do not necessarily have uniform shape or size. To maximize coupling efficiency between the photonic integrated circuit 101 and an external optical component 108, the shape and size of each scatterer 302 may correspond to the position of the scatterer 302 in the arrangement. The arrangement of the scatterers 302 results in the scatterers 302 redirecting optical signals in a desired direction.

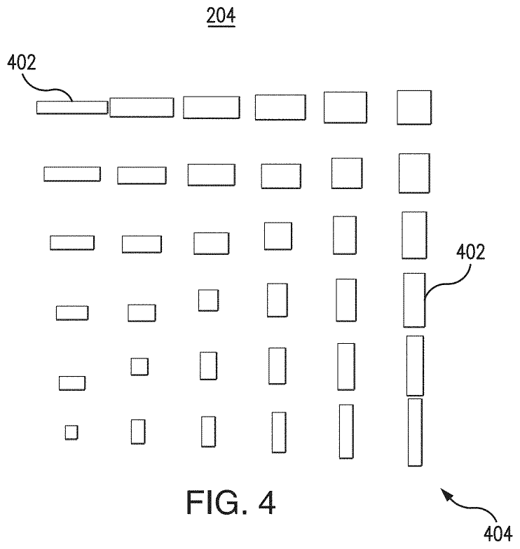

FIG. 4 illustrates a top-down view of an example grating 204 in the system 100 of FIG. 1. As discussed previously, the grating 204 may be overlaid on the grating 202 shown in FIG. 3. The grating 204 is arranged so that in conjunction with grating 202, a grating coupler 104 is formed that redirects optical signals towards the external optical component 108. In particular embodiments, directionality losses of the grating coupler 104 are reduced.

As seen in FIG. 4, the grating 204 includes multiple scatterers 402 in a two-dimensional arrangement. For clarity, not all of the scatterers 402 in the grating 204 are labeled in FIG. 4. The scatterers 402 are arranged in a grating plane 404 of the grating 204. In certain embodiments, the grating 204 is disposed on the grating 202 such that the plane 404 is parallel to the plane 308 in the grating 202.

The scatterers 402 are formed using any suitable material (e.g., a silicon-based material). For example, the scatterers 402 may be formed using a transparent, dielectric material. The dielectric material used for the scatterers 402 may be different from the dielectric material used for the scatterers 302. The scatterers 402 may be formed by etching away portions of the dielectric. The size, shape, and positioning of the scatterers 402 may be controlled through the etching process. In some embodiments, the scatterers 402 are arranged such that the scatterers 402 are offset from the scatterers 302 in the grating 202 when the grating 204 is overlaid on the grating 202. This offsetting of the scatterers 302 and 402 reduces directionality losses in the grating coupler 104.

The shapes and sizes of scatterers 302 and 402 in their respective arrangements may be chosen to match the beam shape of the grating coupler 104 to that of the external optical component 108. The size and shape of the scatterers 402 in grating 204 may be different than those of scatterers 302 in grating 202.

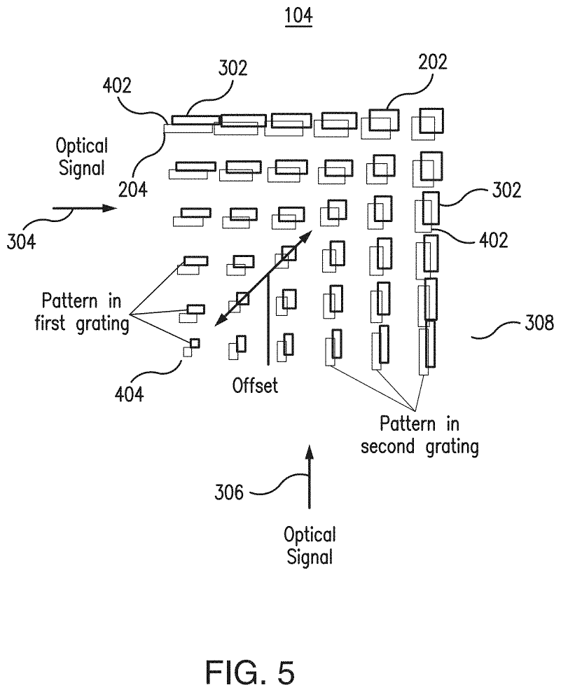

FIG. 5 illustrates an example grating coupler 104 in the system 100 of FIG. 1. As seen in FIG. 5, the grating coupler 104 is formed by overlaying one grating onto another grating. Specifically, the scatterers 402 in the grating 204 (shown in FIG. 4) are overlaid on the scatterers 302 of the grating 202 (shown in FIG. 3) to form the grating coupler 104. The planes 308 and 404 are parallel to each other. Additionally, the scatterers 402 are overlaid onto the scatterers 302 such that the scatterers 402 are offset from the scatterers 302 in a direction that is different from the direction of the optical signals 304 and 306 incident the grating coupler 104.

The optical signals 304 and 306 are incident on the grating coupler 104 from different directions. The optical signals 304 and 306 may enter the grating coupler 104 from any suitable direction and are not limited to entering the grating coupler 104 from the sides of the grating coupler 104. The scatterers 402 are overlaid on the scatterers 302 such that the scatterers 402 are offset from the scatterers 302 in a direction that is different from the directions of the incident optical signals 304 and 306. One or more scatterers 302 and 402 may partially overlap. The offset direction, however, may still be in the plane 308 or the plane 404. In certain embodiments, by offsetting the scatterers 402 from the scatterers 302 in this manner, the grating coupler 104 experiences reduced directionality losses.

The grating coupler 104 may redirect any suitable number (e.g., more than two) optical signals incident on the grating coupler 104 from any suitable number of different directions. The scatterers 302 and the scatterers 402 may still be offset from each other in a direction that is different from these suitable number of different directions.

Although the example of FIG. 5 shows the scatterers 402 having shapes and sizes similar to the shapes and sizes of the scatterers 302, the scatterers 402 may have shapes and sizes that are different from the scatterers 302. For example, the scatterers 302 may be square or rectangular, while the scatterers 402 are circular. Additionally, the example of FIG. 5 shows that the grating coupler 104 includes the same number of scatterers 302 as scatterers 402. However, the grating coupler 104 may include different numbers of scatterers 402 and scatterers 302. As a result, not every scatterer 302 may have a corresponding offset scatterer 402 and not every scatterer 402 may have a corresponding offset scatterer 302.

In some embodiments, an intermediate layer formed using a low index material (e.g., silicon dioxide) is disposed on the grating 202 and planarized before the grating 204 is disposed on the grating 202. This material fills cavities etched into the grating 202 so that the grating 204 does not enter these cavities when the grating 204 is overlaid onto the grating 202. For instance, the material of the intermediate layer may have a refractive index in the range of 1.4-2. In some instances, the material of the intermediate layer may have a refractive index in the range of 1.4-3.48. In certain instances, the low index material may have a refractive index that is lower than the refractive index of the material used to form the grating 202 and/or the grating 204.

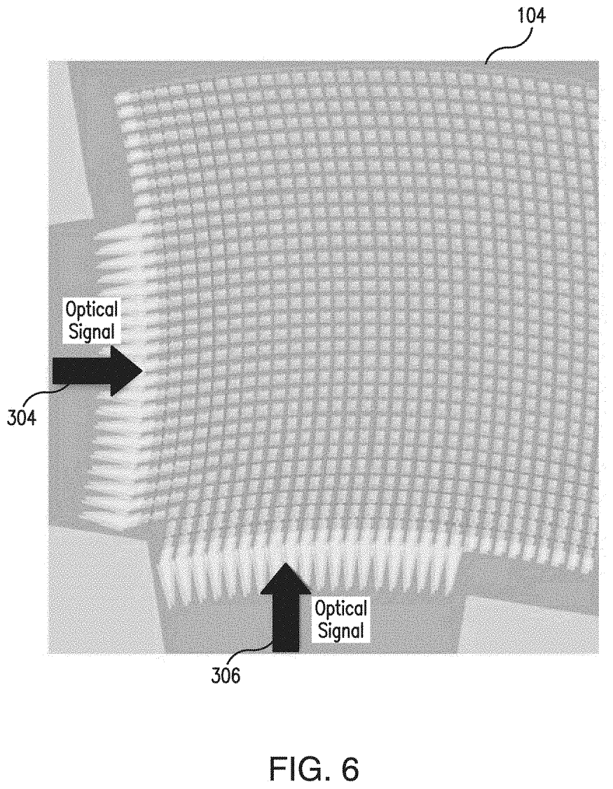

Furthermore, the grating coupler 104 may have any suitable shape. FIG. 6 illustrates an example grating coupler 104 in the system 100 of FIG. 1. As seen in FIG. 6, the arrangement of scatterers in grating coupler 104 may be along curved lines. The optical signals 304 and 306 are incident on the curved surfaces of the grating coupler 104 from different directions. The grating coupler 104 redirects the optical signals 304 and 306 towards the external optical component 108 (shown in FIG. 1).

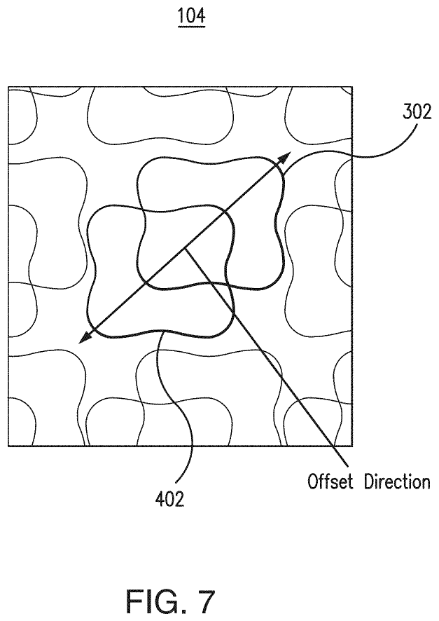

As discussed previously, the scatterers 302 and 402 need not be square or rectangular. FIG. 7 illustrates parts of an example grating coupler 104 in the system 100 of FIG. 1. As seen in FIG. 4, the grating coupler 104 includes scatterers 302 and scatterers 402 overlaid on the scatterers 302. The scatterers 302 and 402 are shaped to resemble petal shapes with curved outlines. Additionally, the scatterer 402 is offset from the scatterer 302 in a direction that is different from the directions of optical signals incident on the grating coupler 104. The offset direction may be in the same plane as the arrangement of the scatterers 302 or the arrangement of the scatterers 402. Although the scatterers 302 and the scatterers 402 in the example of FIG. 7 have the same shape and size, the scatterers 302 and the scatterers 402 may have different shapes and sizes.

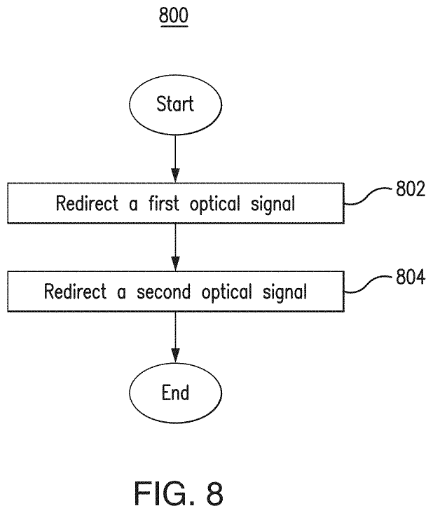

FIG. 8 is a flowchart of an example method 800 performed in the system 100 of FIG. 1. In particular embodiments, the grating coupler 104 performs the steps of the method 800. By performing the method 800, the grating coupler 104 reduces directionality losses when redirecting optical signals that are incident on the grating coupler 104.

In block 802, the grating coupler 104 redirects a first optical signal 304 incident on the grating coupler 104. In block 804, the grating coupler 104 redirects a second optical signal 306 incident on the grating coupler 104. The first optical signal 304 and the second optical signal 306 may be incident on the grating coupler 104 from different directions. For example, the first optical signal 304 and the second optical signal 306 may be orthogonal to each other. The grating coupler 104 may include scatterers 302 in a two-dimensional arrangement in the plane 308 of grating 202. For example, the scatterers 302 may be arranged in a rectangular arrangement in the plane 308 of the grating 202. The scatterers 302 may be formed by etching away portions of a transparent dielectric layer. The sizes and shapes of the scatterers 302 may be controlled through this etching process.

The grating coupler 104 also includes scatterers 402 in a two-dimensional arrangement in the plane 404 of the grating 204. The plane 404 may be parallel to the plane 308 in the grating 202. For example, the scatterers 402 may be arranged in a rectangular arrangement in the plane 404 of the grating 204. The scatterers 402 may be formed by etching away portions of a transparent dielectric layer. The sizes and shapes of the scatterers 402 may be controlled through this etching process.

The grating 204 may be overlaid on the grating 202, such that, some of the scatterers 402 overlap portions of some of the scatterers 302. Moreover, the scatterers 402 may be offset from the scatterers 302 in a direction that is different from the directions of the incident optical signals 304 and 306. The offset direction however may still be in the planes 308 and 404 of the gratings 202 and 204. In certain embodiments, by offsetting the scatterers 402 from the scatterers 302, the grating coupler 104 redirects the optical signals 304 and 306 towards the external optical component 108, while reducing directionality losses in the grating coupler 104.

In some embodiments, an intermediate layer formed using a low index material (e.g., silicon dioxide) is disposed on the grating 202 and planarized before the grating 204 is disposed on the grating 202. This material fills gaps etched into the grating 202 so that the grating 204 does not enter these gaps when the grating 204 is overlaid onto the grating 202.

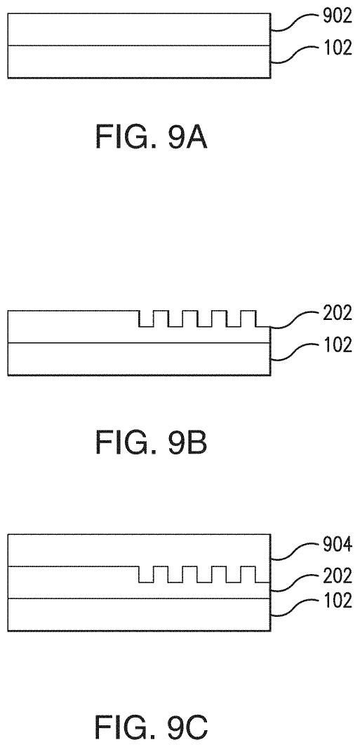

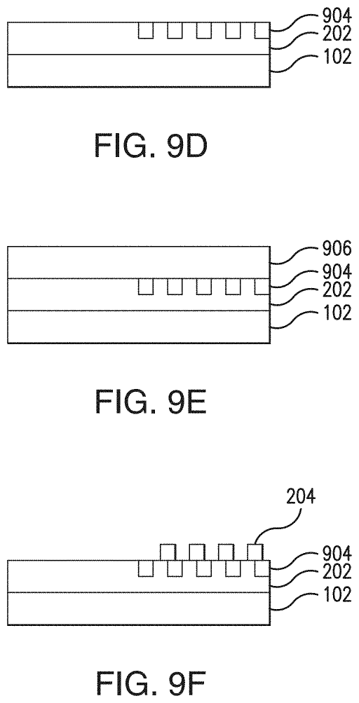

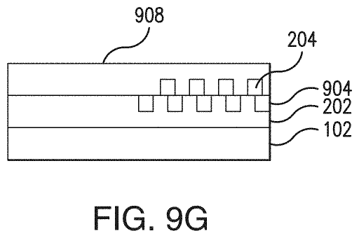

FIGS. 9A through 9G illustrate the formation of an example grating coupler 104 in the system 100 of FIG. 1 in cross-sectional views. As seen in FIG. 9A, the process begins when a layer 902 is disposed on the substrate 102. The layer 902 may be a transparent, dielectric material. The layer 902 may be deposited onto the substrate 102. The substrate 102 forms a foundation for the layer 902 and other components in the grating coupler. In some embodiments, a buried oxide layer is first formed on the substrate 102 before depositing the layer 902. As a result, the layer 902 is disposed above the substrate 102 and on the buried oxide layer.

As seen in FIG. 9B, after the layer 902 is disposed above the substrate 102, the layer 902 is patterned or etched to form the grating 202. During the patterning or etching, portions of the layer 902 are removed to form the two-dimensional arrangement of scatterers 302 in the grating 202. In some embodiments, the grating 202 is formed from the layer 902 through lithography. As discussed previously, the scatterers 302 in the grating 202 may be arranged in a grating plane 308 of the grating 202. The scatterers 302 may have any suitable size, shape, and positioning to redirect incident optical signals in a particular direction. The scatterers 302 may not have uniform shape or size. Rather, the shape and size of each scatterer 302 corresponds to the position of the scatterer 302 in the arrangement.

As seen in FIG. 9C, after the grating 202 is formed, a layer 904 is disposed on the grating 202. The layer 904 may be formed using a low index material (e.g., silicon dioxide). Additionally, the layer 904 may fill the etched cavities in the grating 202 when the layer 904 is disposed on the grating 202. In some embodiment, the layer 904 is deposited onto the grating 202.

As seen in FIG. 9D, after the layer 904 is disposed on the grating 202, the layer 904 is planarized or polished. During the planarization process, portions of the layer 904 are removed such that the layer 904 does not extend beyond the top surface of the grating 202, in this specific embodiment. As a result, the portions of the layer 904 within the etched cavities of the grating 202 may remain, but portions of the layer 904 that extend above the grating 202 may be removed. In this manner, the remaining layer 904 prevents other materials from being disposed in the etched cavities of the grating 202. In another embodiment, the layer 904 may be planarized, but a continuous film may remain on top of the grating 202. This layer can be used to introduce a separation between the grating 202 and the grating 204.

As seen in FIG. 9E, after the layer 904 is planarized, a layer 906 is disposed on the grating 202 and the layer 904. The layer 906 may be deposited onto the grating 202 and the layer 904. The layer 906 may be a transparent, dielectric material. The layer 906 may be deposited onto the grating 202 and the layer 904 such that the layer 906 is overlaid on the grating 202 and the layer 904. The layer 904 prevents portions of the layer 906 from being disposed in the etched cavities of the grating 202. The dielectric material used for the layer 904 may not be the same dielectric material used for the layer 902 or the grating 202.

As seen in FIG. 9F, after the layer 906 is disposed on the grating 202 and the layer 904, the layer 906 is patterned or etched to form the grating 204. In some embodiments, the grating 204 is formed from the layer 906 using lithography. During the patterning or etching, portions of the layer 906 are removed to form the two-dimensional arrangement of scatterers 402 in the grating 204. The size, shape, and positioning of the scatterers 402 may be controlled through the etching process. FIG. 9F shows layer 906 fully etched, however, a partial etch may also be considered. As discussed previously, the scatterers 402 in the grating 204 may be arranged in a grating plane 404 of the grating 204. The scatterers 402 may have any suitable size, shape, and positioning to redirect incident optical signals in a particular direction. The scatterers 402 may not have uniform shape or size. Rather, the shape and size of each scatterer 402 corresponds to the position of the scatterer 402 in the arrangement.

In certain embodiments, the scatterers 402 in the grating 204 are overlaid on the scatterers 302 in the grating 202 such that the scatterers 402 are offset from the scatterers 302 in a direction that is different from the direction of optical signals 304 and 306 incident on the grating 202, as shown in FIG. 5. In this manner, the grating coupler 104, comprising gratings 202 and 204, redirects the optical signals while reducing directionality losses. Additionally, in some embodiments, some of the scatterers 402 at least partially overlap some of the scatterers 302.

Moreover, the number of scatterers 402 in the grating 204 may be different from the number of scatterers 302 in the grating 202. As a result, not every scatterer 302 is offset from a corresponding scatterer 402 or not every scatterer 402 is offset from a corresponding scatterer 302. Additionally, the scatterers 402 do not necessarily have the same size and shape as the scatterers 302. Scatterers 302 and 402 may be formed from different materials.

As seen in FIG. 9G, after the grating 204 is formed, a layer 908 is disposed (e.g., deposited) on the grating 204. The layer 908 may be a superstrate layer formed using an oxide material. The layer 908 may protect the top surfaces of the gratings 202 and 204.

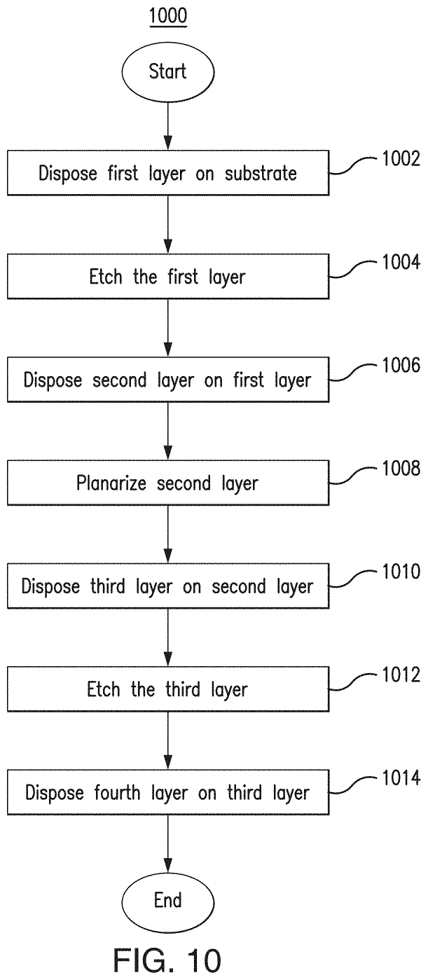

FIG. 10 is a flowchart of an example method 1000 for forming the grating coupler 104 of FIGS. 9A through 9G. In particular embodiments, an operator or administrator may use different fabrication machinery to perform the steps of the method 1000. By performing the method 1000, a grating coupler 104 is formed. The grating coupler 104 includes layers of gratings with scatterers that are offset from each other, which reduces directionality losses in the grating coupler 104.

In block 1002, the operator disposes a first layer 902 onto a substrate 102. In some embodiments, the operator may first form a layer (e.g., a buried oxide layer) on the substrate 102 before disposing the first layer 902. As a result, the first layer 902 is disposed above the substrate 102 and on the layer. The layer disposed on the substrate 102 may have a lower refractive index than the first layer 902. The first layer 902 may be a transparent dielectric material. The substrate 102 forms a foundation for the grating coupler 104, and may be made using any suitable material (e.g., semiconductor materials).

In block 1004, the operator etches the first layer 902. The etching removes portions of the first layer 902, which forms the scatterers 302 in the grating 202. As a result, the etching process forms the grating 202. The size, shape, and positioning of the scatterers 302 may be controlled through the etching process. The scatterers 302 may be etched in a two-dimensional arrangement. As discussed previously, the scatterers 302 in the grating 202 may be arranged in a grating plane 308 of the grating 202. The scatterers 302 may not have uniform shape or size. Rather, the shape and size of each scatterer 302 corresponds to the position of the scatterer 302 in the arrangement.

In block 1006, the operator disposes a second layer 904 onto the grating 202. The second layer 904 may be a low index material (e.g., silicon dioxide). Additionally, the second layer 904 may fill the etched cavities in the grating 202 when the second layer 904 is disposed on the grating 202.

In block 1008, the operator planarizes the second layer 904. By planarizing the second layer 904, portions of the second layer 904 may be removed to form a flat surface. As a result, the second layer 904 that filled the etched cavities of the grating 202 may remain. In this manner, the remaining layer 904 prevents other materials from being disposed in the etched cavities of the grating 202. The second layer 904 may be removed to the level of grating 202, so that no continuous film remains of the second layer 904 and only the cavities of grating 202 are filled.

In block 1010, the operator disposes a third layer 906 onto the grating 202 and the second layer 904. The third layer 906 may be a transparent dielectric material. The layer 906 may be deposited onto the grating 202 and the layer 904 such that the layer 906 is overlaid on the grating 202 and the layer 904. The layer 904 prevents portions of the layer 906 from being disposed in the etched cavities of the grating 202. The dielectric material used for the layer 904 may not be the same dielectric material used for the layer 902 or the grating 202.

In block 1012, the operator etches the third layer 906 to form the grating 204. Specifically, the operator etches the third layer 906 to form the scatterers 402 in the grating 204. The size, shape, and positioning of the scatterers 402 may be controlled through this etching process. The scatterers 402 may be arranged in a two-dimensional arrangement in the grating plane 404 of the grating 204. The grating plane 404 may be parallel to the grating plane 308 of the grating 202. The scatterers 402 may not have uniform shape or size. Rather, the shape and size of each scatterer 402 corresponds to the position of the scatterer 402 in the arrangement.

The scatterers 402 may be positioned such that the scatterers 402 are offset from the scatterers 302 in the grating 202. In some embodiments, the scatterers 402 are offset from the scatterers 302 in a direction that is different from the directions of optical signals incident on the grating coupler 104. However, the directions of the optical signals and the direction of the offset may be in the same plane. For example, the direction of the offset and the directions of the optical signals may be in the grating plane 308 of the grating 202 or the grating plane 404 of the grating 204.

In block 1014, the operator disposes a fourth layer 908 onto the grating 204. The fourth layer 908 may be an oxide material that protects the gratings 202 and 204.

In summary, a dual-layer grating coupler 104 uses offset scatterers 302 and 402 in stacked gratings 202 and 204 to redirect optical signals 304 and 306. Specifically, the grating coupler 104 includes a first grating 202 and a second grating 204 overlaid on the first grating 202. Both gratings 202 and 204 include scatterers 302 and 402 in two-dimensional (2D) arrangements in parallel grating planes 308 and 404. Generally, the scatterers 402 in the second grating 204 are offset from the scatterers 302 in the first grating 202 in a direction that is different from the direction of optical signals 304 and 306 incident on the first grating 202. For example, a first optical signal 304 and a second optical signal 306 may enter the grating coupler 104 from two different directions, and the scatterers 402 in the second grating 204 are offset from the scatterers 302 in the first grating 202 in a third direction that is different from the two directions of the incident optical signals 304 and 306. In this manner, the dual-layer grating coupler 104 redirects the optical signals 304 and 306 while reducing losses (e.g., directionality losses) relative to conventional 2D grating couplers, in certain embodiments.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. An apparatus comprising:
a first grating comprising a first plurality of scatterers in a first two-dimensional (2D) arrangement; and
a second grating in a stack with the first grating, wherein:
the second grating comprises a second plurality of scatterers in a second 2D arrangement,
the first grating and the second grating are arranged to redirect a first optical signal and a second optical signal traveling through the stack,
the first optical signal enters the stack in a first direction and the second optical signal enters the stack in a second direction different from the first direction, and
each of the second plurality of scatterers is offset from a corresponding scatterer of the first plurality of scatterers in a third direction different from the first and second directions.

2. The apparatus of claim 1, wherein the first plurality of scatterers has a different shape or size than the second plurality of scatterers.

3. The apparatus of claim 1, wherein the first direction is orthogonal to the second direction.

4. The apparatus of claim 1, wherein the first 2D arrangement is curved.

5. The apparatus of claim 4, wherein the second 2D arrangement is curved.

6. The apparatus of claim 1, wherein the first grating is made of a different material than the second grating.

7. The apparatus of claim 1, wherein the second grating comprises fewer scatterers than the first grating.

8. The apparatus of claim 1, wherein the stack is arranged to redirect the first optical signal or the second optical signal between a photonic integrated circuit and an external optical component.

9. The apparatus of claim 1, further comprising:
a substrate; and
an oxide layer disposed on the substrate, wherein the first grating is disposed on the oxide layer.

10. The apparatus of claim 1, wherein a scatterer of the second plurality of scatterers partially overlaps a corresponding scatterer of the first plurality of scatterers.

11. The apparatus of claim 1, wherein the first grating and the second grating are further arranged to redirect a third optical signal traveling through the stack in a fourth direction different from the first direction, the second direction, and the third direction.

12. The apparatus of claim 1, further comprising an intermediate layer disposed between the first grating and the second grating.

13. An apparatus comprising:
a substrate; and
a grating coupler arranged above the substrate, wherein the grating coupler comprises a plurality of gratings arranged to redirect a plurality of optical signals traveling through the grating coupler in a plurality of different directions, wherein the plurality of gratings comprises a plurality of 2D arrangements of scatterers, and wherein scatterers in a first 2D arrangement of the plurality of 2D arrangements are offset from scatterers in a second 2D arrangement of the plurality of 2D arrangements in a direction different from the plurality of different directions.

14. The apparatus of claim 13, wherein the scatterers in the first 2D arrangement have a different shape or size than the scatterers in the second 2D arrangement.

15. The apparatus of claim 13, wherein the first 2D arrangement and the second 2D arrangement are curved.

16. The apparatus of claim 13, wherein the scatterers in the first 2D arrangement are made of a different material than the scatterers in the second 2D arrangement.

17. The apparatus of claim 13, wherein a scatterer in the first 2D arrangement partially overlaps a scatterers in the second 2D arrangement.

18. A method comprising:
disposing a first layer above a substrate;
etching the first layer to form a first grating comprising a first plurality of scatterers;
disposing a second layer on the first layer; and
etching the second layer to form a second grating comprising a second plurality of scatterers such that the first layer and the second layer form a grating coupler arranged to redirect a first optical signal traveling through the grating coupler in a first direction and a second optical signal traveling through the grating coupler in a second direction different from the first direction, wherein one or more of the second plurality of scatterers at least partially overlaps with and is offset from a corresponding scatterer of the first plurality of scatterers in a third direction different from the first and second directions.

19. The method of claim 18, further comprising disposing a layer on the substrate with a refractive index lower than a refractive index of the first layer, wherein the first layer is disposed on the layer disposed on the substrate.

20. The method of claim 18, further comprising disposing an intermediate layer on the first layer after etching the first layer.
